(19) United States
(12) Patent Application Publication
(10) Pub. No.: US 2010/0046019 A1
(43) Pub. Date: Feb. 25, 2010

(54) SYSTEM AND METHOD FOR ADMINISTERED DOCUMENT PROCESSING DEVICE CLONING

(76) Inventors: Sheng W. LEE, Irvine, CA (US); Amir Shahindoust, Laguna Niguel, CA (US); Michael L. Yeung, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/195,694

(22) Filed: Aug. 21, 2008

(51) Int. Cl. G06F 3/12

(52) U.S. Cl. 358/1.13

(57) ABSTRACT

The subject application is directed to a system and method for administered document processing device cloning. Selection data is received identifying a selected one of a plurality of networked document processing devices. A configuration data query is generated from an administrative workstation to the selected document processing device via an associated data network. Configuration data is received from the selected document processing device via the data network and is stored in an associated storage. Each of the target document processing devices is sequentially selected, and received configuration data is communicated from the storage to each target document processing device via the data network. An update signal is output to commence a configuration update of each target document processing device in accordance with received configuration data communicated thereto, and status data is received from each target document processing device corresponding to a configuration update thereon.

### BACKGROUND OF THE INVENTION

The subject application is directed generally to configuration of data devices. The application is particularly applicable to administrative configuration of networked document processing devices by cloning of configuration settings via an administrative workstation.

Document processing devices in widespread use include copiers, printers, facsimile machines, electronic mail servers, and scanners. More recently, two or more of these functions have been placed in a single device referred to as a multifunction peripheral (MFP) or multifunction device (MFD).

Business or office environments typically employ many document processing devices that are connected with workstations, servers, and one another via a data network. Many such environments employ tens or even hundreds of networked devices, which may exist on multiple floors, multiple buildings, or even in multiple cities. Sophisticated devices typically require settings to be selected relative to the many functions that can be enabled or disabled, as well as customized interfaces, user accounts, billing codes, and the like. It can be extremely burdensome for an administrator to independently access and configure a large number of machines.

### SUMMARY OF THE INVENTION

In accordance with one embodiment of the subject application, there is provided a system and method for administered document processing device cloning. Selection data is received identifying a selected one of a plurality of networked document processing devices. A configuration data query is generated from an administrative workstation to the selected document processing device via an associated data network. Configuration data is received from the selected document processing device via the data network corresponding to a configuration thereof and is stored in an associated storage. Each of a plurality of target document processing devices is sequentially selected, and received configuration data is communicated from the storage to each target document processing device via the data network. An update signal is output to commence a configuration update of each target document processing device in accordance with received configuration data communicated thereto, and status data is received from each target document processing device corresponding to a configuration update thereon.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system according to one embodiment of the subject application;

FIG. 2 is a block diagram illustrating device hardware for use in the system according to one embodiment of the subject application;

FIG. 3 is a functional diagram illustrating the device for use in the system according to one embodiment of the subject application;

FIG. 4 is a block diagram illustrating controller hardware for use in the system according to one embodiment of the subject application;

FIG. 5 is a functional diagram illustrating the controller for use in the system according to one embodiment of the subject application;

FIG. 6 is a functional diagram illustrating a user device for use in the system according to one embodiment of the subject application;

FIG. 7 is a block diagram illustrating the system according to one embodiment of the subject application;

FIG. 8 is a functional diagram illustrating the system according to one embodiment of the subject application;

FIG. 9 is a flowchart illustrating a method according to one embodiment of the subject application; and

FIG. 10 is a flowchart illustrating a method according to one embodiment of the subject application.

### DETAILED DESCRIPTION OF THE PREFERRED EMBODIMENT

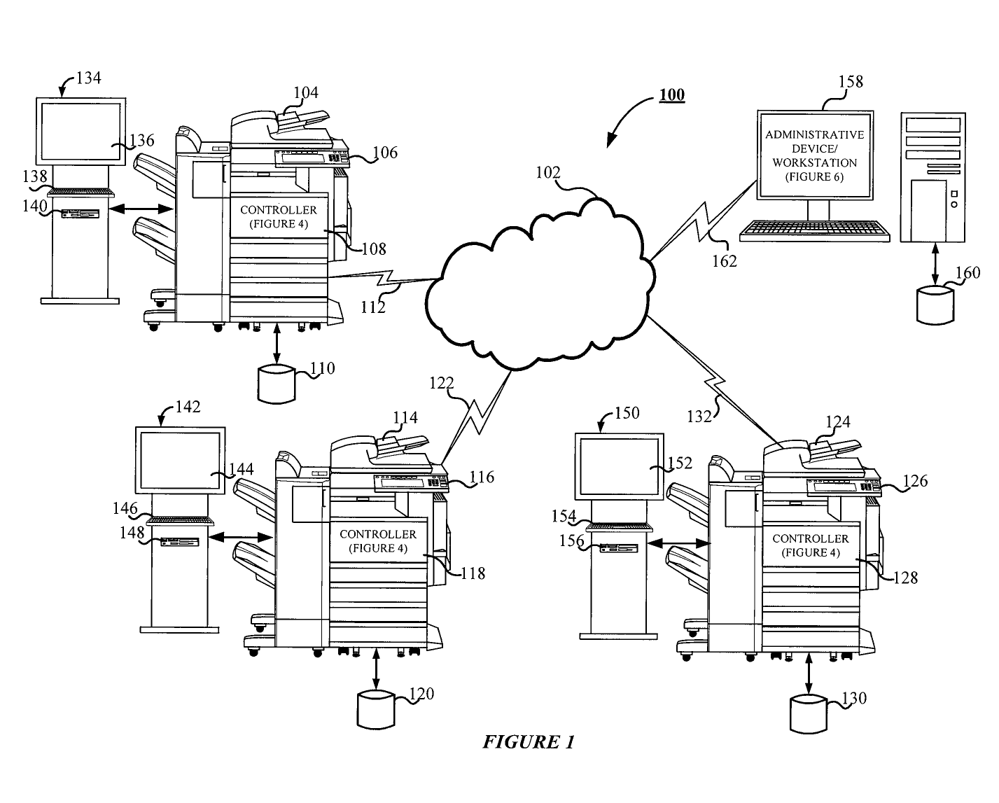

The subject application is directed to a system and method for remote device administration. In particular, the subject application is directed to a system and method for configuration of data devices. More particularly, the subject application is directed to a system and method that enable administrative configuration of networked document processing devices by cloning of configuration settings via an administrative workstation. It will become apparent to those skilled in the art that the system and method described herein are suitably adapted to a plurality of varying electronic fields employing remote device interactions including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for administered document processing device cloning in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes one or more document processing devices, depicted in FIG. 1 as the document processing devices 104, 114, and 124. As shown in FIG. 1, the document processing devices 104, 114, and 124 are illustrated as multifunction peripheral devices suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, and any suitable combination thereof configured to interact with an associated user, a networked device, or the like.

According to one embodiment of the subject application, the document processing devices 104, 114, and 124 are suitably equipped to receive a plurality of portable storage media including, without limitation, Firewire drive, USB drive, SD, MMC, XD, compact flash, memory stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and to receive selections from such associated users.

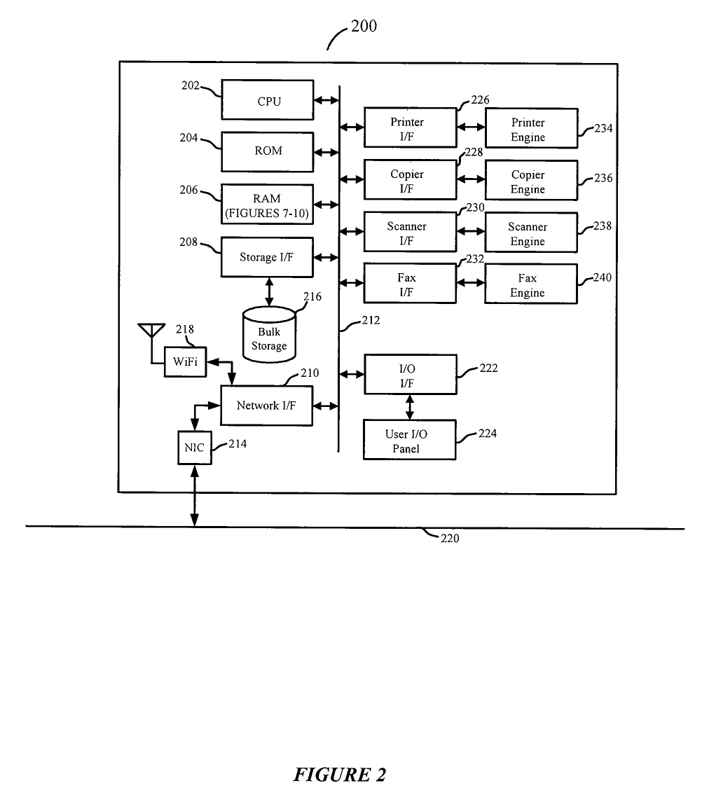

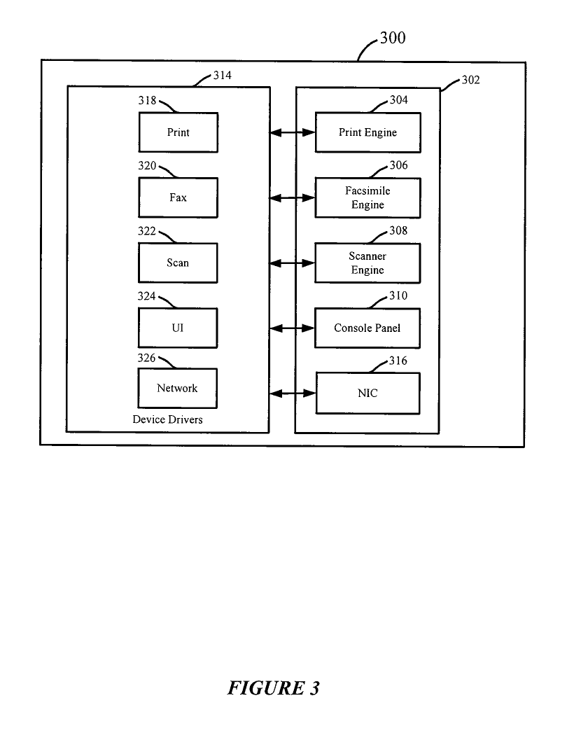

The skilled artisan will appreciate that the user interfaces 106, 116, and 126 comprise various components suitably adapted to present data to associated users, as are known in the art. In accordance with one embodiment of the subject application, the user interfaces 106, 116, and 126 comprise a display suitably adapted to display one or more graphical elements, text data, images, or the like to an associated user, to receive input from the associated user, and to communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

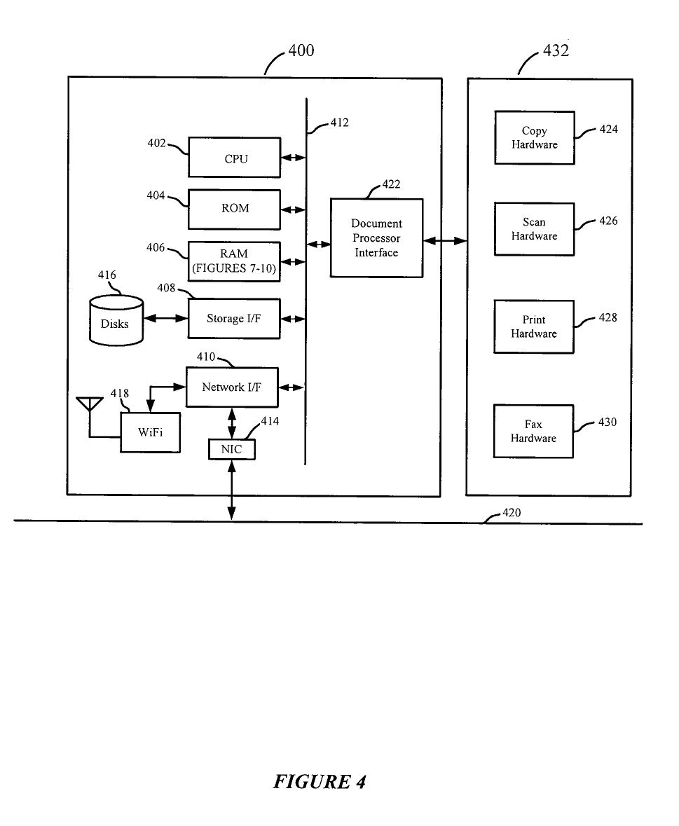

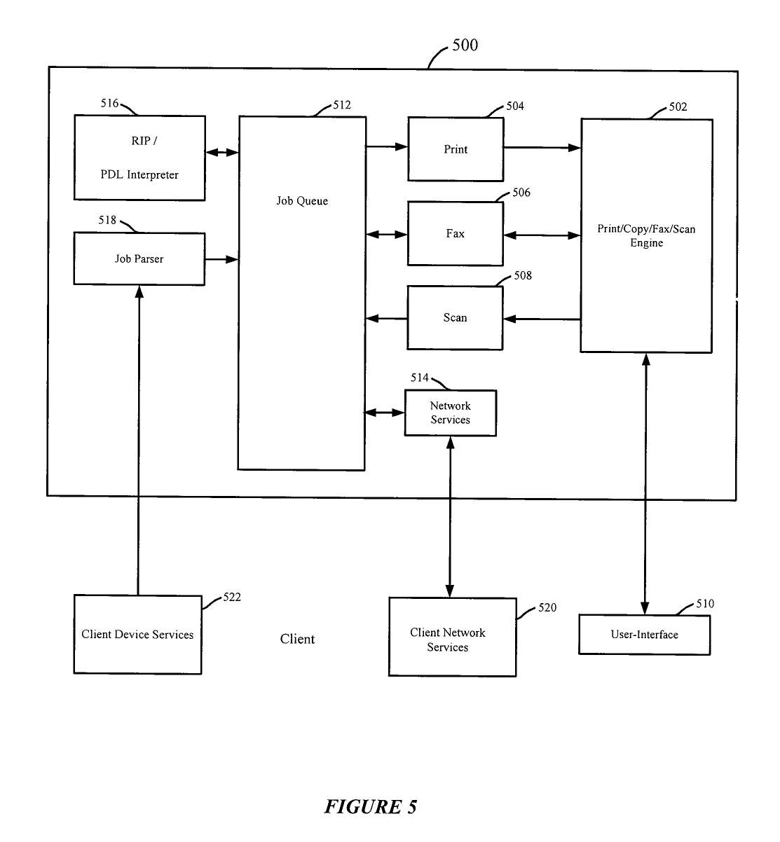

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof configured to control the operations of the associated document processing devices 104, 114, and 124, to facilitate the display of images via the user interfaces 106, 116, and 126, to direct the manipulation of electronic image data, and the like. For purposes of explanation, the controllers 108, 118, and 128 are used to refer to any of the myriad components associated with the document processing devices 104, 114, and 124, including hardware, software, or combinations thereof functioning to perform, cause to be performed, control, or otherwise direct the methodologies described hereinafter. It will be understood by those skilled in the art that the methodologies described with respect to the controllers 108, 118, and 128 are capable of being performed by any general purpose computing system known in the art, and thus the controllers 108, 118, and 128 are representative of such a general computing device and are intended as such when used hereinafter. Furthermore, the use of the controllers 108, 118, and 128 hereinafter is for the example embodiment only, and other embodiments that will be apparent to one skilled in the art are capable of employing the system and method for administered document processing device cloning including an administrative workstation of the subject application. The functioning of the controllers 108, 118, and 128 will be better understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store document data, image data, electronic database data, or the like. It will be appreciated by those skilled in the art that, while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like such as, for example and without limitation, an internal hard disk drive or the like.

Illustrated in FIG. 1 are a first kiosk 134 communicatively coupled to the first document processing device 104 and, in effect, to the computer network 102; a second kiosk 142 communicatively coupled to the second document processing device 114 and, in effect, to the computer network 102; and a third kiosk 150 communicatively coupled to the third document processing device 124 and, in effect, to the computer network 102. It will be appreciated by those skilled in the art that the kiosks 134, 142, and 150 are capable of being implemented as separate components of the respective document processing devices 104, 114, and 124, or as integral components thereof. Use of the kiosks 134, 142, and 150 in FIG. 1 are for example purposes only, and the skilled artisan will appreciate that the subject application is capable of implementation without the use of kiosks 134, 142, and 150. In accordance with one embodiment of the subject application, the kiosks 134, 142, and 150 include respective displays 136, 144, and 152 and user input devices 138, 146, and 154. As will be understood by those skilled in the art, the kiosks 134, 142, and 150 are capable of implementing a combination user input device/display such as a touch screen interface. According to one embodiment of the subject application, the kiosks 134, 142, and 150 are suitably adapted to display selected advertisements to prospective customers, to display prompts to an associated user, to receive instructions from the associated user, to receive payment data, to receive selection data from the associated user, and the like. Preferably, the kiosks 134, 142, and 150 include a magnetic card reader, conventional bar code reader, or the like suitably adapted to receive and read payment data from a credit card, coupon, debit card, or the like.

The system 100 of FIG. 1 also includes portable storage device readers 140, 148, and 156 coupled to the kiosks 134, 142, and 150 and suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

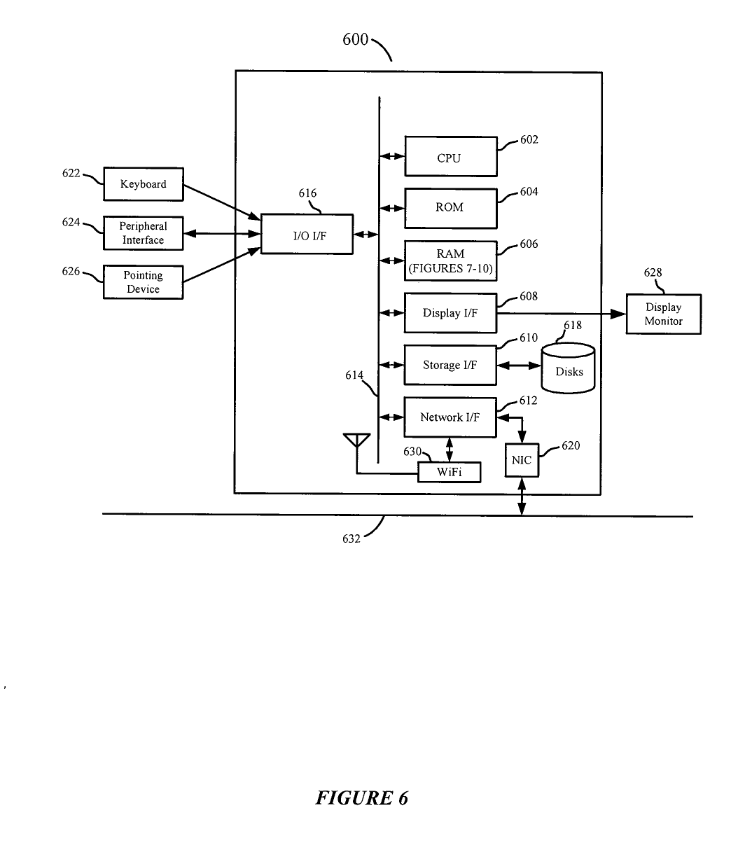

The system 100 illustrated in FIG. 1 further depicts an administrative device 158 in data communication with the computer network 102 via a communications link 162. It will be appreciated by those skilled in the art that the administrative device 158 is shown in FIG. 1 as a computer workstation for illustration purposes only. As will be understood by those skilled in the art, the administrative workstation 158 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 162 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative workstation 158 is suitably adapted to monitor operations of the computer network 102; the document processing devices 104, 114, and 124 or any other similar device coupled to the computer network 102; and the like. According to one embodiment of the subject application, the administrative workstation 158 is suitably configured to employ a thin client interface, e.g. a web-browser, dedicated software application, dedicated hardware, or the like via which an associated administrative user is capable of monitoring device status, configurations, workloads, and the like, providing such devices with operating or configuration instructions, and the like. The functioning of the administrative workstation 158 will better be understood in conjunction with the block diagram illustrated in FIG. 6, explained in greater detail below.

Communicatively coupled to the administrative workstation 158 is the data storage device 160. In accordance with the preferred embodiment of the subject application, the data storage device 160 is any mass storage device, or plurality of such devices, known in the art including, for example and without limitation, magnetic storage drives, a hard disk drive, optical storage devices, flash memory devices, or any suitable combination thereof. According to one embodiment of the subject application, the data storage device 160 is suitably adapted to store device status data, device configuration data, update data, workload data, electronic documents, administrative policies, image data, account data, user data, and the like. It will be appreciated by those skilled in the art that, while illustrated in FIG. 1 as being a separate component of the system 100, the data storage device 160 is capable of being implemented as internal storage component of the administrative workstation 158 or the like such as, for example and without limitation, an internal hard disk drive or the like.

Turning now to FIG. 2, illustrated is a representative architecture of a suitable device 200, shown in FIG. 1 as the document processing devices 104, 114, and 124, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing devices 104, 114, and 124, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406, suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controllers 108, 118, and 128) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative workstation 158, for use in connection with the subject system. A suitable workstation includes a processor unit 602 that is advantageously placed in data communication with read only memory 604, suitably non-volatile read only memory, volatile read only memory or a combination thereof; random access memory 606; display interface 608; storage interface 610; and network interface 612. In a preferred embodiment, interface to the foregoing modules is suitably accomplished via a bus 614.

The read only memory 604 suitably includes firmware, such as static data or fixed instructions such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device, as will be appreciated by one of ordinary skill in the art.

The storage interface 610 suitably provides a mechanism for non-volatile, bulk, or long-term storage of data or instructions in the workstation 600. The storage interface 610 suitably uses a storage mechanism, such as storage 618, suitably comprised of a disk, tape, CD, DVD, or other relatively higher-capacity addressable or serial storage medium.

The network interface 612 suitably communicates to at least one other network interface, shown as network interface 620, such as a network interface card, and wireless network interface 630, such as a WiFi wireless network card. It will be appreciated by one of ordinary skill in the art that a suitable network interface is comprised of both physical and protocol layers and is suitably any wired system, such as Ethernet, Token-Ring, or any other wide area or local area network communication system or wireless system, such as WiFi, WiMax, or any other suitable wireless network system, as will be appreciated by one of ordinary skill in the art. In the illustration, the network interface 620 is interconnected for data interchange via a physical network 632 suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface, as may be appropriate for a selected application. Finally, the input/output interface 616 is suitably in data communication with a pointing device interface 626 for connection with devices such as a mouse, light pen, touch screen, or the like.

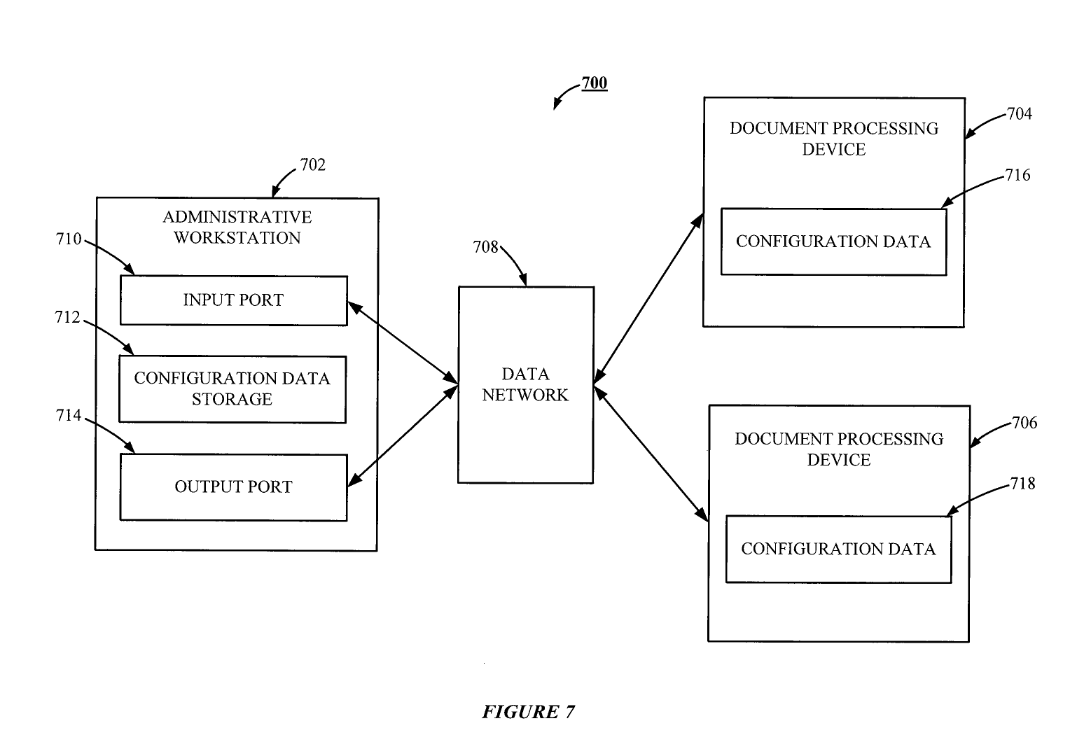

Turning now to FIG. 7, illustrated is a block diagram of a system 700 for administered document processing device cloning including an administrative workstation, in accordance with one embodiment of the subject application. As shown in FIG. 7, the system 700 includes an administrative workstation 702 and a plurality of document processing devices 704 and 706 in data communication via a data network 708. The administrative workstation 702 includes an input port 710, a configuration data storage 712, and an output port 714. The input port 710 is preferably configured to be operative to receive configuration data from a selected one of the document processing devices 704 or 706 via the data network 708. The configuration data storage 712 associated with the administrative workstation 702 is suitably configured to store configuration data 716 or 718 received from the selected document processing device 704 or 706. According to one embodiment of the subject application, the output port 714 associated with the administrative workstation 702 is configured to be operative to communicate configuration data from the configuration data storage 712 to at least a second of the plurality of document processing devices 704 or 706 via the data network 708.

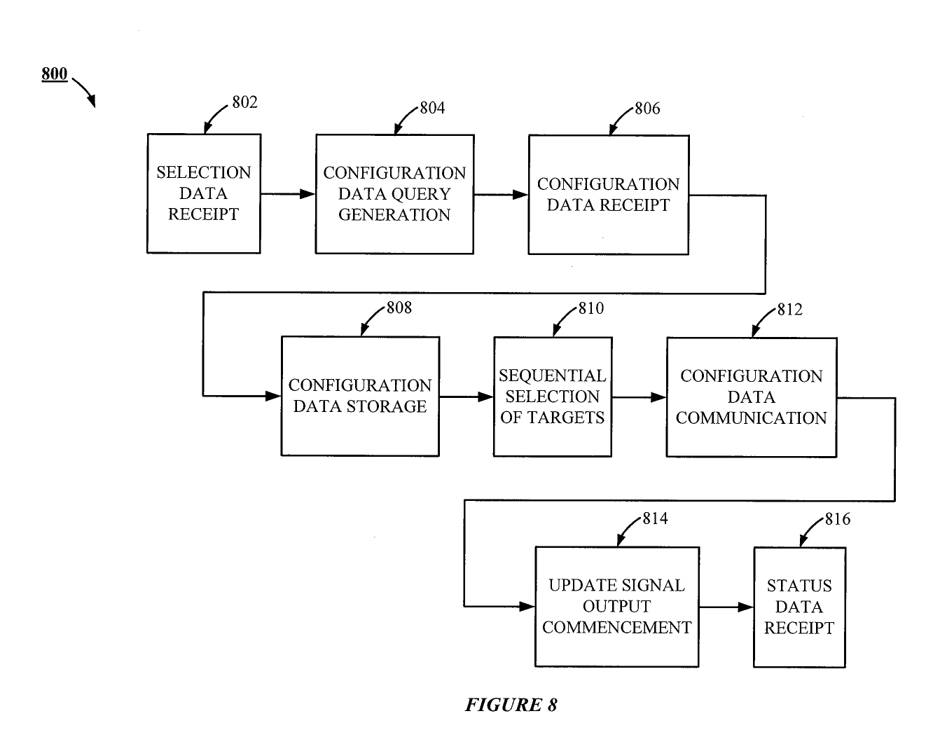

Turning now to FIG. 8, illustrated is a functional diagram of a system 800 for administered document processing device cloning including an administrative workstation, in accordance with one embodiment of the subject application. As shown in FIG. 8, selection data receipt 802 occurs, identifying a selected one of a plurality of networked document processing devices 104, 114, and 124 by the administrative workstation 158. The administrative workstation 158 then performs configuration data query generation 804. Configuration data receipt 806 then occurs at the administrative workstation 158, corresponding to a response from the selected document processing device 104, 114, or 124 to the generated configuration query 804. Configuration data storage 808 then occurs by the administrative workstation 158, corresponding to the response from the selected document processing device 104, 114, or 124 to the configuration data query; that is, configuration data storage 808 occurs of configuration data received from the selected document processing device 104, 114, or 124 by the administrative workstation 158.

Sequential selection of targets 810, e.g. the desired document processing devices 104, 114, and/or 124, then occurs via the administrative workstation 158. Configuration data communication 812 is then performed via the data network 102 to each sequentially selected targeted device 104, 114, and/or 124. Update signal output commencement 814 then occurs, representing the output of an update signal from the administrative workstation 158 to the selected targeted document processing devices 104, 114, and/or 124. Status data receipt 816 then occurs with respect to status data of the configuration update being received by the administrative workstation 158 from each targeted document processing device 104, 114, and/or 124.

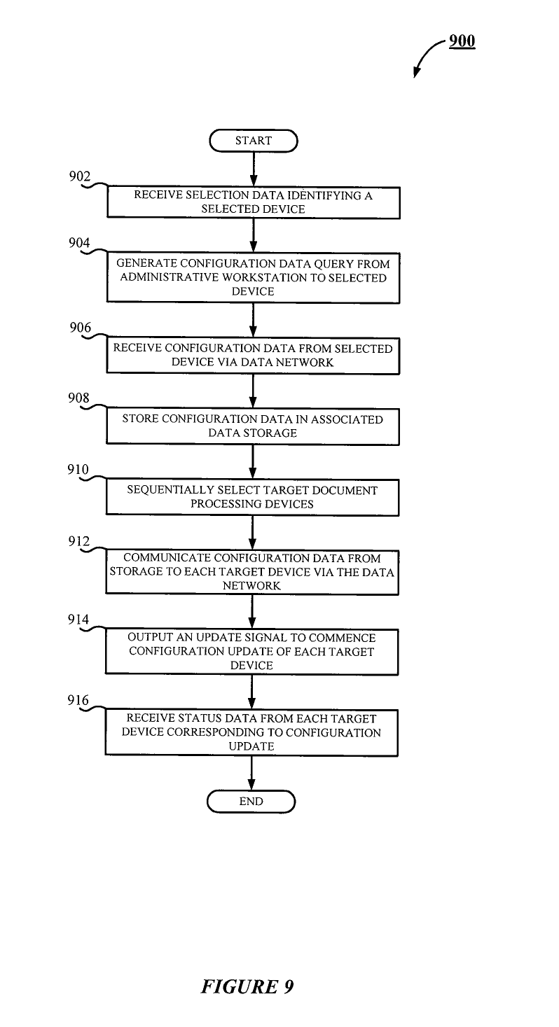

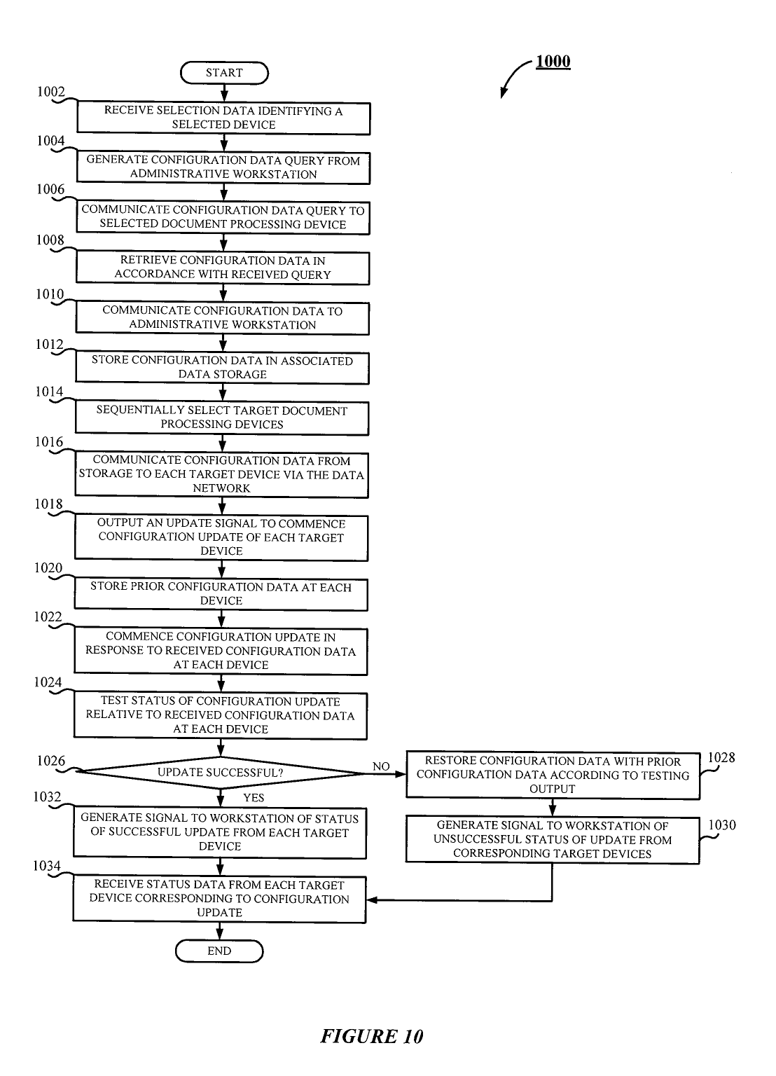

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for administered document processing device cloning including an administrative workstation, in accordance with one embodiment of the subject application. Beginning at step 902, the administrative workstation 158 receives selection data identifying one of the document processing devices 104, 114, or 124. At step 904, the administrative workstation 158 generates a configuration data query to the selected document processing device 104, 114, or 124.

At step 906, the administrative workstation 158 receives configuration data from the selected document processing device 104, 114, or 124 via the data network 102. In accordance with one embodiment of the subject application, the configuration data received from a selected document processing device 104, 114, or 124 includes, for example and without limitation, network settings, resource usage settings, processing operation settings, user access settings, administrative settings, policy settings, energy settings, remote access settings, or any of the myriad other such configuration settings, as will be appreciated by those skilled in the art. At step 908, the administrative workstation 158 stores the received configuration data in associated data storage, e.g. the data storage device 160 communicatively coupled to the administrative workstation 158.

Target document processing devices 104, 114, and/or 124 are then sequentially selected for receipt of the configuration data at step 910. At step 912, the administrative workstation 158 communicates the configuration data from the data storage device 160 to each of the targeted document processing devices 104, 114, and/or 124 via the computer network 102. The administrative workstation 158 then outputs an update signal at step 914 to each of the targeted document processing devices 104, 114, and/or 124 to commence a configuration update thereon in accordance with the communicated configuration data. The administrative workstation 158 then receives, at step 916, status data from each target device 104, 114, and/or 124, corresponding to the status of the configuration update being performed thereon.

Referring now to FIG. 10, there is shown a flowchart 1000 illustrating a method for administered document processing device cloning including an administrative workstation, in accordance with one embodiment of the subject application. The methodology of FIG. 10 begins at step 1002, whereupon the administrative workstation 158 receives selection data corresponding to a desired document processing device 104, 114, or 124 from amongst those devices 104, 114, and 124 in data communication via the computer network 102. That is, the administrative workstation 158, via a suitable application resident thereon, receives selection data of a source device 104, 114, or 124 from an administrator from which device 104, 114, or 124 configuration data is to be retrieved, stored, and used to “clone” such configuration to other devices 104, 114, and/or 124. For example purposes only, reference is made herein to the first document processing device 104 as the device identified by the selection data received by the administrative workstation 158 at step 1002. The skilled artisan will appreciate that any of the devices 104, 114, or 124 are equally capable of being used as the selected device in accordance with the subject application.

At step 1004, the administrative workstation 158 generates a configuration data query for the selected document processing device 104 corresponding to the selected features, settings, or the like associated with the selected document processing device 104. In accordance with one embodiment of the subject application, a graphical user interface or other suitable user interface means are enabled via the administrative workstation 158 so as to allow the associated user to select desired configuration data associated with the selected document processing device 104. At step 1006, the administrative workstation 158 communicates the generated configuration data query to the selected document processing device 104 via the computer network 102. The controller 108 or other suitable component associated with the document processing device 104 then retrieves configuration data in response to the received query at step 1008. At step 1010, the controller 108 or other suitable component associated with the document processing device 104 communicates configuration data to the administrative workstation 158 in accordance with the received query.

The administrative workstation 158 receives the configuration data from the selected document processing device 104 and stores the configuration data in the data storage device 160 associated with the administrative workstation 158 at step 1012. Target document processing devices, e.g. devices 114 and 124, are then sequentially selected by an administrator via the administrative device 158 at step 1014. In accordance with one embodiment of the subject application, the administrative device 158 is suitably configured to automatically selected target devices, e.g. based upon the type of device, manufacturer, current operating systems, or other desired distinguishing characteristic, as will be appreciated by those skilled in the art.

At step 1016, the administrative workstation 158 communicates configuration data from the data storage 160 to each of the target document processing devices 114 and 124 via the computer network 102. An update signal is then output by the administrative workstation 158 at step 1018, directing the commencement of a configuration update by the target devices 114 and 124 in accordance with the communicated configuration data. The target devices 114 and 124 receive the update configuration data via the computer network 102, and the controllers 118 and 128 or other suitable components associated with the target document processing devices 114 and 124 store prior configuration data at step 1020. That is, each of the target document processing devices 114 and 124 store their current configurations on the data storage devices 120 and 130.

The controllers 118 and 128 or other suitable components associated with the target document processing devices 114 and 124 then commence a configuration update in response to the received configuration data at step 1022. At step 1024, the controllers 118 and 128 test the status of the configuration update of their respective document processing devices 114 and 124 relative to the received configuration data. A determination is then made at step 1026 as to whether the configuration update is successful. Upon a determination at step 1026 that the configuration update is not successful, flow proceeds to step 1028. At step 1028, the controller 118 and 128 or other suitable component associated with the targeted document processing devices 114 and 124 restores the prior configuration data. A signal to the administrative workstation 158 is then generated at step 1030, indicating the unsuccessful configuration update status of the corresponding document processing device 114 and/or 124. Status data is then received from each target document processing device 114 and 124 by the administrative device 158 at step 1034 corresponding to the configuration update.

Upon a determination at step 1026 that the configuration update is successful, flow proceeds to step 1032. At step 1032, the controllers 118 and 128 or other suitable components associated with the target document processing devices 114 and 124 respectively generate a signal to the administrative workstation 158 indicating the successful configuration update. Operations then progress to step 1034, whereupon the administrative workstation 158 receives the status data corresponding to the configuration update from each of the targeted document processing devices 114 and 124.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for administered document processing device cloning, comprising:
an administrative workstation;
a plurality of document processing devices;
a data network;
an input port on the administrative workstation operative to receive configuration data from a selected one of the document processing devices via the data network;
a configuration data storage associated with the administrative workstation; and
an output port on the administrative workstation operative to communicate 1o configuration data from the configuration data storage to at least a second of the plurality of document processing devices via the data network.

2. The system of claim 1, further comprising a verification input on the administrative workstation operative to receive status data corresponding to a status of configuration of the second of the plurality of document processing devices.

3. The system of claim 2, wherein each of the plurality of document processing devices include:
configuration data stored in an associated data storage;
an input port operative to receive data from the administrative workstation via the data network;
a configuration update system operative on configuration data received from the administrative workstation; and
a backup storage for prior configuration data.

4. The system of claim 3, wherein each of the plurality of document processing devices further includes:
a comparator operative to determine success of a configuration update; and
a status data output operative via the comparator.

5. A method for administered document processing device cloning including an administrative workstation, comprising the steps of:
receiving selection data identifying a selected one of a plurality of networked document processing devices;
generating a configuration data query from an administrative workstation to the selected document processing device via an associated data network;
receiving configuration data from the selected document processing device via the data network corresponding to a configuration thereof;
storing received configuration data in an associated storage;
sequentially selecting each of a plurality of target document processing devices;
communicating received configuration data from the storage to each target document processing device via the data network;
outputting an update signal to commence a configuration update of each target document processing device in accordance with received configuration data communicated thereto; and
receiving status data from each target document processing device corresponding to a configuration update thereon.

6. The method of claim 5, further comprising the steps of:
receiving configuration data from the network at each target document processing device;
storing prior configuration data at each target document processing device; and
responsive to a received update signal, commencing a configuration update with received configuration data at each target document processing device.

7. The method of claim 6, further comprising the steps of:
testing a status of a configuration update relative to received configuration data at each target document processing device; and
generating a signal to the administrative workstation corresponding to a status of a configuration update in accordance with an output of the testing at each target document processing device.

8. The method of claim 7, further comprising the step of restoring configuration data with prior configuration data in accordance with an output of the testing at each target document processing device.

9. A system for administered document processing device cloning including an administrative workstation, comprising:
means adapted for receiving selection data identifying a selected one of a plurality of networked document processing devices;
means adapted for generating a configuration data query from an administrative workstation to the selected document processing device via an associated data network;
means adapted for receiving configuration data from the selected document processing device via the data network corresponding to a configuration thereof;
storage means adapted for storing received configuration data;
means adapted for sequentially selecting each of a plurality of target document processing devices;
means adapted for communicating received configuration data from the storage means to each target document processing device via the data network;
means adapted for outputting an update signal to commence a configuration update of each target document processing device in accordance with received configuration data communicated thereto; and
means adapted for receiving status data from each target document processing device corresponding to a configuration update thereon.

10. The system of claim 9, wherein each target document processing device includes:
means adapted for receiving configuration data from the network;
means adapted for storing prior configuration data; and
means, responsive to a received update signal, for commencing a configuration update with received configuration data.

11. The system of claim 10, wherein each target document processing device includes:
testing means adapted for testing a status of a configuration update relative to received configuration data; and
means adapted for generating a signal to the administrative workstation corresponding to a status of a configuration update in accordance with an output of the testing means.

12. The system of claim 11, wherein each target document processing device includes means adapted for restoring configuration data with prior configuration data in accordance with an output of the testing means.
